(19) United States
(12) Patent Application Publication
(10) Pub. No.: US 2006/0080835 A1
(43) Pub. Date: Apr. 20, 2006

(54) Methods for manufacture of multilayered multifunctional truss structures and related structures there from

(76) Inventors: Gregory W. Kooistra, Silverdale, WA (US); Haydn N.G. Wadley, Keswick, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 10/545,042

(22) PCT Filed: Feb. 17, 2004
(86) PCT No.: PCT/US04/04608

§ 371 Date: Aug. 11, 2005

Related U.S. Application Data
(60) Provisional application No. 60/447,549, filed on Feb. 14, 2003.

(51) Int. Cl. B23P 11/00

(52) U.S. Cl. 29/897.34; 29/505; 29/509; 29/514

(57) ABSTRACT

A method for manufacturing multilayered truss cores, which solves, among other things, key issues of bonding monolayered truss cores to one another. A multilayered truss core may be created from a single planar perform of an appropriate geometric pattern. Once the desired preform is manufactured it is then deformed into a three-dimensional (3D) truss network. This approach bypasses the need to stack and join monolayer truss cores, eliminating the additional tooling, lay-up, and interlayer bonding process steps. These multilayered cores may then be attached to facesheets or the like to form multilayered truss core panels or other multifunctional structures.

### RELATED APPLICATIONS

This application claims priority under 35 U.S.C Section 119(e) of the earlier filing date of U.S. Provisional Application Serial. No. 60/447,549, filed on Feb. 14, 2003, entitled “Methods for Manufacture of Multilayered Multifunctional Truss Structures and Related Structures there from,” of which the entire disclosure is hereby incorporated by reference herein.

### US GOVERNMENT RIGHTS

This invention was made with United States Government support under Grant No. N00014-03-1-0281, awarded by the Defense Advanced Research Projects Agency/Office of Naval Research. The United States Government has certain rights in the invention.

### FIELD OF THE INVENTION

The present invention relates generally to methods capable of producing multilayered truss core topologies from preform materials, as well as the structures produced there from.

### BACKGROUND OF THE INVENTION

Stiff lightweight structural sandwich panels utilizing honeycomb type core have seen widespread commercial use for the many decades. Within the past several years new sandwich panels and methods for their manufacture have been invented. These panels employ three dimensional truss networks as core elements. Characteristic topologies include, but are not limited to Octet-truss, tetrahedral, pyramidal, and three-dimensional (3D) Kagomé designs. These panels possess the ability to match the specific stiffness and strength of honeycomb (and other closed cell systems) and provide opportunities for multifunctional applications. In addition to mechanical load support these truss networks possess good heat dissipation characteristics because of the ability to flow fluids through the open structure. The functionality may be extended by the placement of other elements within the core. These include, but are not limited to ceramic prisms, ceramic particulate infusions, and high tenacity polymeric yarns and fabrics.

Periodic cellular metals have been manufactured by various methods including: investment casting, lattice block construction, constructed metal lattice and metal textile lay-up techniques. The techniques for manufacturing periodic cellular metals enable the metal topology to be controlled so that efficient load supporting structures may be constructed.

To date, a method for the manufacture of multilayered truss cores from a single planar preform has yet to be introduced. The present invention provides the methods capable of producing multilayered truss core topologies from planar preform materials, as well as the structure produced there from.

### BRIEF SUMMARY OF INVENTION

The present invention method developed for manufacturing multilayered truss cores solves key issues of bonding monolayered truss cores to one another. In an embodiment of the present invention, a multilayered truss core may be created from a single planar preform of an appropriate topology. Once the desired preform is manufactured it is then deformed into a three-dimensional (3D) truss network. This approach bypasses the need to stack and join monolayer truss cores, eliminating, among other things, the additional tooling, lay-up, and interlayer bonding process steps. These multilayered cores may then be attached to facesheets or the like to form multilayered truss core panels.

The materials for manufacturing the present invention truss cores encompass any material subject to deformation; these include, but are not limited to, metals, metal alloys, inorganic polymers, organic polymers, ceramics, glasses, semiconductors, electronic materials, photonic materials, and all composite derivatives.

The planar preforms appropriate for deformation include, but are not limited to, patterned and stamped sheet goods, woven textiles, perforated sheets, expanded sheet goods (e.g., expanded metal), and hollow tube arrays.

The methods for deforming the preforms include, but are not limited to, conventional punch die type tool operations (i.e., pushing technique), nodal tension expansion (i.e., pulling technique), forging, and electric discharge forming. A key to the deformation process is to make sure the material preform is in its ductile temperature regime. The scales of truss core thicknesses that can be produced with this method range from the hundreds of micrometers to several meters, but not limited thereto.

The multifunctional features of these panels address specific problems in the arenas of ballistic projectile/fragment capture. The truss core panel offers a high stiffness to weight and high energy absorption to weight ratio for civil, aerospace, and military structures. The truss core panels can be further augmented, for a minimal weight increase, to contain errant or intended ballistic projectiles (bullets, turbine blade fragments, shrapnel, flying debris, etc.). This is achieved by the addition of polymeric fabric strips on the interior faces of the metal facesheets. These fabrics act as nets to snare incoming flying objects. Additionally, engineered ceramics (i.e., aluminum oxide, silicon carbide, boron carbide, or titanium diboride) may be added to the truss core void spaces (interstitial spaces). The ceramic elements further enhance the projectile capture ability of the truss core panel.

An aspect of an embodiment of the present invention includes a method of making a multilayered truss core. The method comprising 1) providing a preform member of appropriate topology including a plurality of intersecting members, wherein nodes are formed at the intersections, and 2) bending the preform member to form a multilayer truss core, wherein: a) predetermined selection of the plurality of the nodes remain at least substantially in or are bent at least substantially into a first plane, b) predetermined selection of the plurality of the nodes are bent at least substantially into a second plane distal from the first plane, and c) predetermined selection of the plurality of the nodes are bent at least substantially into, a third plane distal from the first plane and opposite from the second plane, whereby the first plane is between the second plane and the third plane to form the truss core. Optionally, this bending of the preform member results in predetermined selection of the plurality of the nodes are bent at least substantially into a fourth plane that is either 1) distal from second plane and opposite direction from the third plane, whereby the second plane is between the first plane and the fourth plane, or 2) distal from third plane and opposite direction from the second plane, whereby the third plane is between the first plane and the fourth plane.

An aspect of an embodiment of the present invention includes a multilayered truss core structure comprised of: at least two integrally formed layers of truss arrays, wherein the layers are free of bonds adapted to otherwise join the first and second layers together. It is conceivable that the two layers form a bilayered truss core. Additionally, the multilayered truss core may comprise an integrally formed (or non-integrally formed) third layer immediately adjacent to either the first or second layer.

An aspect of an embodiment of the present invention includes a three dimensional multilayered truss core structure comprised of: at least two integrally formed layers of truss arrays, wherein the layers are integrally formed with one another without casting. Additionally, the multilayered truss core may comprise a third layer immediately adjacent to the first or second layer without casting. Alternatively the third layer could be in mechanical communication with the first of second layer that is not considered integrally formed.

These and other objects, along with advantages and features of the invention disclosed herein, will be made more apparent from the description, drawings, and claims that follow.

### BRIEF SUMMARY OF THE DRAWINGS

The foregoing and other objects, features and advantages of the present invention, as well as the invention itself, will be more fully understood from the following description of potential embodiments, when read together with the accompanying drawings in which:

FIG. 1(A) is a schematic plan view of the monolayer tetrahedral truss core preform. Nodes designated with a (+) indicate the point to be deformed above or approximately thereto the starting reference plane. Nodes designated with a (°) indicate the point that remains in-plane or approximately thereto.

FIGS. 1(B)-(C) are an isometric view and a partial elevation view, respectively, of the 3D tetrahedral truss core monolayer after deformation of the preform shown in FIG. 1(A).

FIG. 2(A) is a schematic plan view of the multilayered tetrahedral truss core preform. Above plane, in-plane, and below plane (or approximately thereto) nodes are designated (+), (°), and (−), respectively.

FIGS. 2(B)-(C) are an isometric view and partial elevation view, respectively, of the 3D multilayer core after deformation of the preform as shown in FIG. 2(A).

FIG. 3(A) is a front schematic view of one row of punch and die adapted to interlock one another for an embodiment of the present invention bending technique.

FIG. 3(B) is a top plan schematic view of one row of a punch and die adapted to interlock one another, as shown in FIG. 3(A) for an embodiment of the present invention bending technique.

FIG. 3(C) is an elevation view of 1) one row of a punch and die depicting the approximate completion of a bending segment to achieve the desired multilayer truss; and 2) a second row of a punch and die depicting a segment of the preform prior to bending into its desired multilayer truss form.

FIG. 3(D) is a schematic plan view of two rows of a punch and die relative to the preform as shown in FIG. 3(C).

FIG. 4(A) is a schematic plan view of the monolayer pyramidal truss core preform. Nodes designated with a (+) indicate the point to be deformed above or approximately thereto the starting reference plane. Nodes designated with a (°) indicate the point that remains in-plane or approximately thereto.

FIGS. 4(B)-(C) are an isometric view and a partial elevation view, respectively, of the 3D pyramidal monolayer truss core after deformation of the preform shown in FIG. 4(A).

FIG. 5(A) is a schematic plan view of the topology of a multilayered pyramidal truss core preform. Above plane, in-plane, and below plane (or approximately thereto) nodes are designated (+), (°), and (−), respectively.

FIGS. 5(B)-(C) are an isometric view and a partial elevation view, respectively, of the 3D pyramidal multilayer truss core after deformation of the preform shown in FIG. 5(A).

FIG. 6(A) is a schematic plan view of the topology of a trilayered pyramidal truss core preform. Above plane, in-plane, and below plane (or approximately thereto) nodes are designated (+), (°), and (−), respectively. The nodes of the highest plane will be given a (++) symbol.

FIGS. 6(B)-(C) are an isometric view and a partial elevation view, respectively, of the 3D pyramidal trilayered truss core after deformation of the preform shown in FIG. 6(A).

FIGS. 7(A)-(D) provide photographic depictions, at various perspective views, of a completed tetrahedral multilayered truss core bonded to facesheets to form a sandwich panel.

FIGS. 8(A)-(B) are a schematic plan view and perspective view, respectively, of the multilayered truss core sandwich structure with a partial cut away section exposing a prism in the interstitial area of the truss.

FIG. 8(C) is an elevation view of the multilayered truss core sandwich structure shown in FIGS. 8(A)-(B).

FIGS. 9(A)-(D) illustrate the various components that may make up the final septoid preform Above plane, in-plane, and below plane nodes are designated (+), (°), and (−), respectively.

FIG. 9(E) provides perspective view of the multilayered truss core sandwich structure with a partial cut away section exposing the three-dimensional multilayer truss layer after deformation of the preform shown in FIG. 9(D).

FIG. 9(F) is an elevation view of the multilayered truss core sandwich structure shown in FIG. 9(E).

### DETAILED DESCRIPTION OF THE INVENTION

The method developed for manufacturing multilayered truss cores solves, among other things, key issues of bonding monolayered truss cores to one another. According to aspects of the present invention, a multilayered truss core may be created from a single planar preform of an appropriate geometric pattern. Once the desired preform is manufactured it is then deformed into a three-dimensional (3D) truss network. This approach bypasses the need to stack and join monolayer truss cores, eliminating the additional tooling, lay-up, and interlayer bonding process steps. These multilayered cores may then be attached to facesheets to form multilayered truss core panels.

In an embodiment of the present invention, the production of the multilayers of a given truss(es) may require, but not limited thereto, four considerations. First, the material selected for the preform may be chosen to meet specific or desired design criteria. Such as performance requirements of the truss core or overall structure, cost of manufacturing the truss core or overall structure, service environment expected for truss core or overall structure, etc. A second consideration is the preform topology, which may be determined, for example, by the number of layers required, geometric constraints, and the form of the material chosen (i.e., stamped monolith, woven textile, etc.). A third consideration is the thermal history of the material and/or the thermal conditions for the deformation process. A Fourth consideration is the deformation method and/or tool, which may driven by the preform topology.

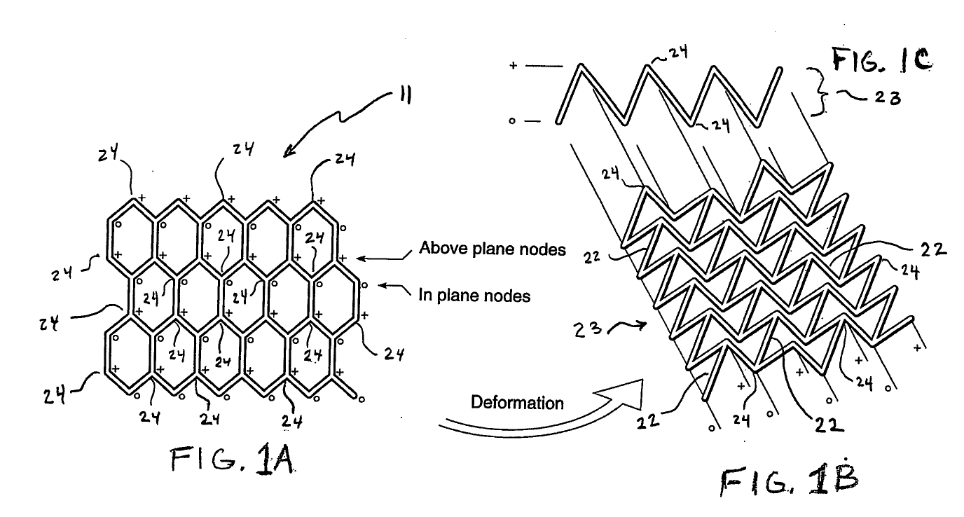

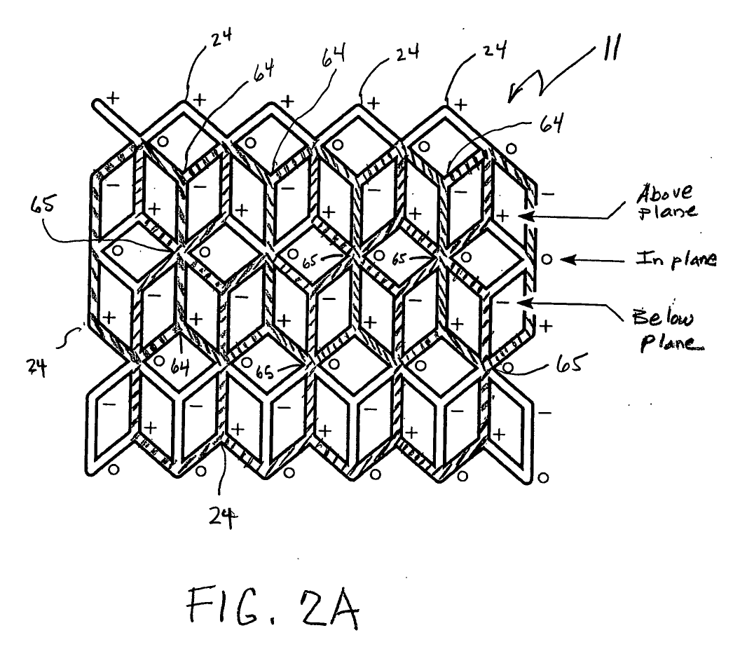

Referring to FIG. 1(A), FIG. 1(A) is a schematic plan view of the monolayer tetrahedral truss core preform 11. Nodes 24 designated with a (+) indicate the point to be deformed above or approximately thereto the starting reference plane. Nodes 24 designated with a (°) indicate the point that remains in-plane or approximately thereto. FIGS. 1(B)-(C) are an isometric view and a partial elevation view, respectively, of the three-dimensional, tetrahedral, truss core monolayer 23 after deformation of the preform 11 shown in FIG. 1(A). The truss core monolayer 23 is comprised of an array of three-dimensional monolayer truss units 22, which are tetrahedral.

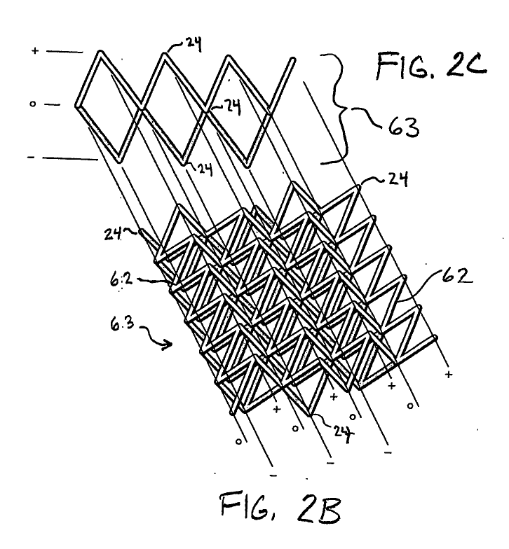

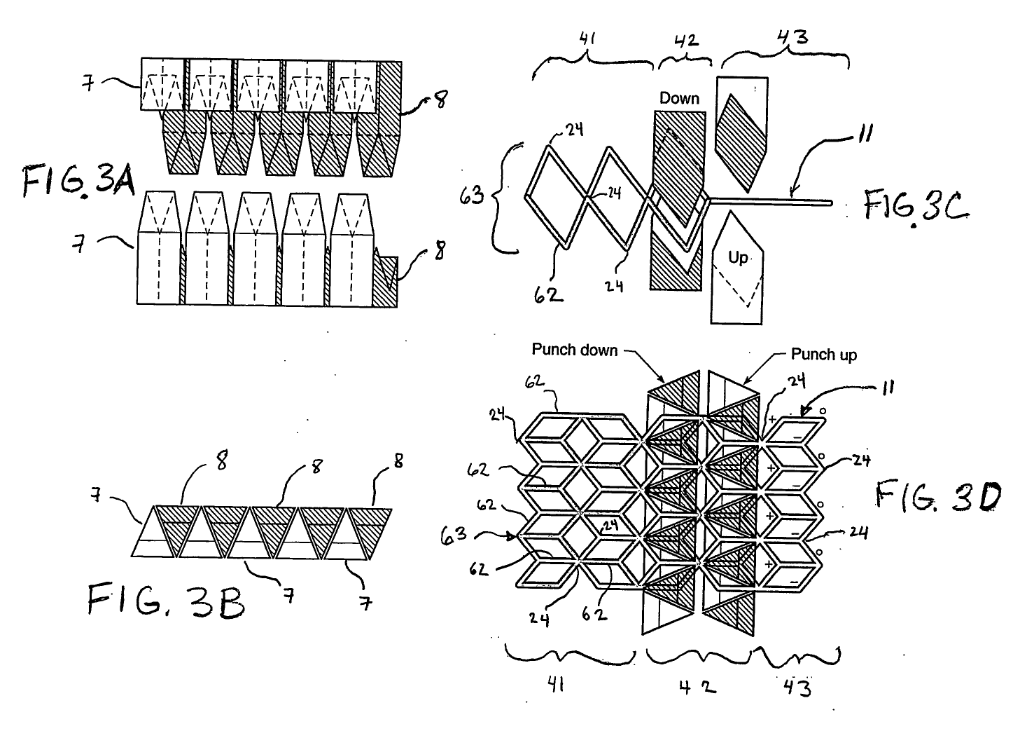

Referring to FIG. 2(A), FIG. 2(A) is a schematic plan view of the multilayered tetrahedral truss core preform 11. Above plane, in-plane, and below plane (or approximately thereto) nodes 24 are designated (+), (°), and (−), respectively. FIGS. 2(B)-(C) are an isometric view and partial elevation view, respectively, of a three dimensional multilayer truss core 63 comprised of a plurality three-dimensional multilayer truss units 62 (here shown as tetrahedral) after deformation of the preform 11 as provided in FIG. 2(A). As shown in FIG. 2(A), the demonstrated topology of the preform 11 is based on an elongated hexagonal lattice as designated with backward slashes (\\\\) with a second hexagonal lattice overlaid and offset as designated with forward slashes (////) creating an array of three-point nodes 64 and six-point nodes 65. It should be appreciated that the topology of the preform 11 is not limited to hexagonally based lattices.

Next, turning to FIG. 3, FIG. 3(A) is a schematic front view of one row of punch 7 and die 8 adapted to interlock one another for an embodiment of the present invention bending/deforming/shaping technique. FIG. 3(B) is a schematic top plan view of one row of a punch 7 and die 8 adapted to interlock one another, as shown in FIG. 3(A) for an embodiment of the present invention bending technique. Next, as shown in FIG. 3(C), an embodiment of the present invention deforming method uses the alternating punch and die tool 7, 8 in a comb-like configuration. FIG. 3(C) is an elevation view of one row of a punch 7 and die 8 depicting a segment, generally represented by region 42, of the preform 11 being bent to achieve the desired multilayer truss layer. A second row of a punch and die is shown depicting a segment, generally represented by region 43, of the preform prior to bending into its desired multilayer truss form. The segment generally represented by region 41, is the resultant multilayer truss layer 63. Similarly, FIG. 3(D) is a schematic plan view of two rows of a punch and die 7, 8 relative to the preform as shown in FIG. 3(C).

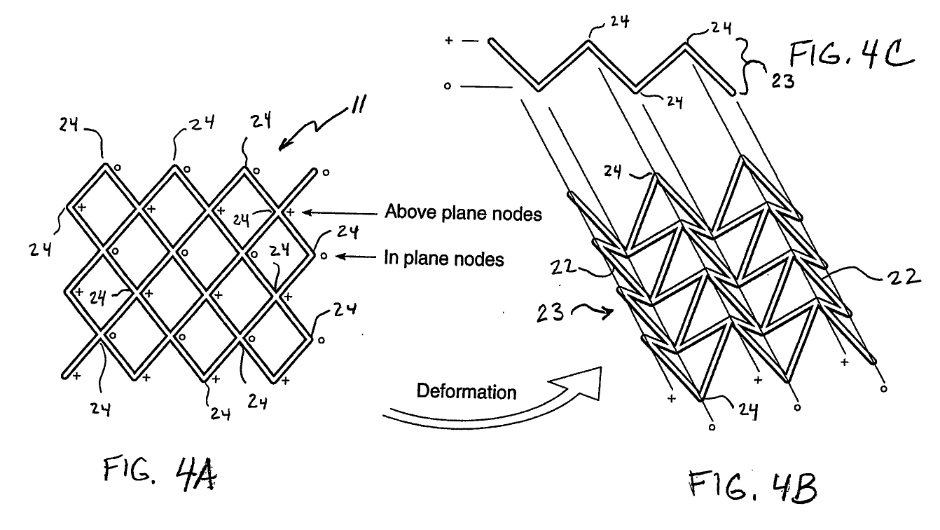

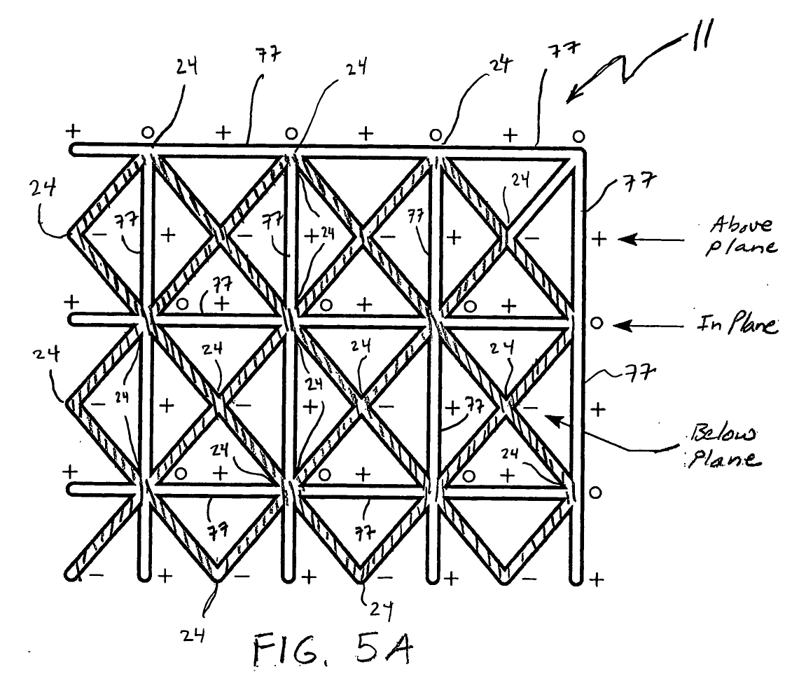

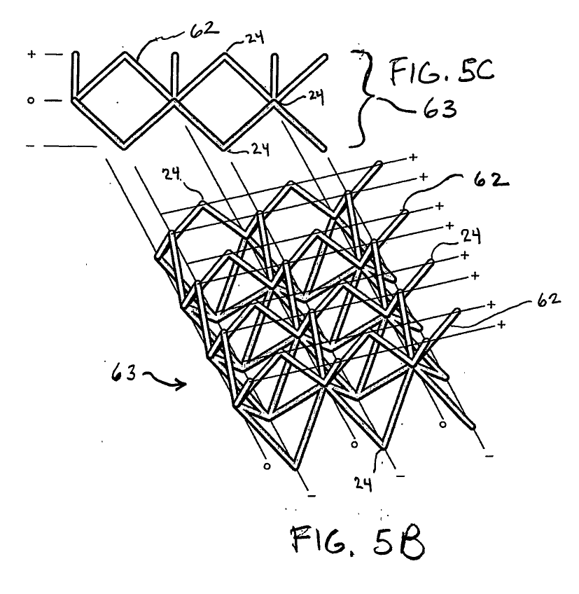

Referring to FIG. 4, FIG. 4(A) is a schematic plan view of the monolayer tetrahedral truss core preform 11. Nodes 24 designated with a (+) indicate the point to be deformed above or approximately thereto the starting reference plane. Nodes 24 designated with a (°) indicate the point that remains in-plane or approximately thereto. FIGS. 4(B)-(C) are an isometric view and a partial elevation view, respectively, of the three-dimensional, pyramidal, truss core monolayer 23 after deformation of the preform 11 shown in FIG. 4(A). The truss core monolayer 23 is comprised of an array of three-dimensional monolayer truss units 22, which are pyramidal.

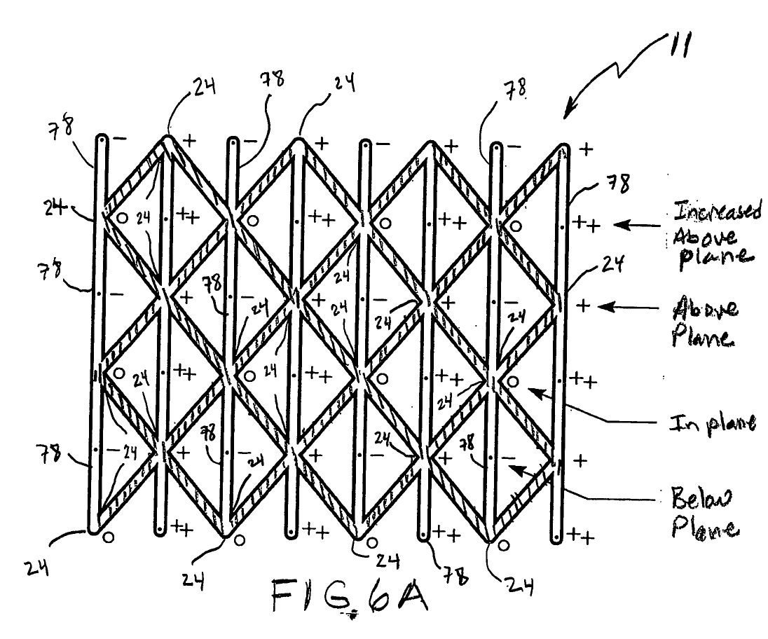

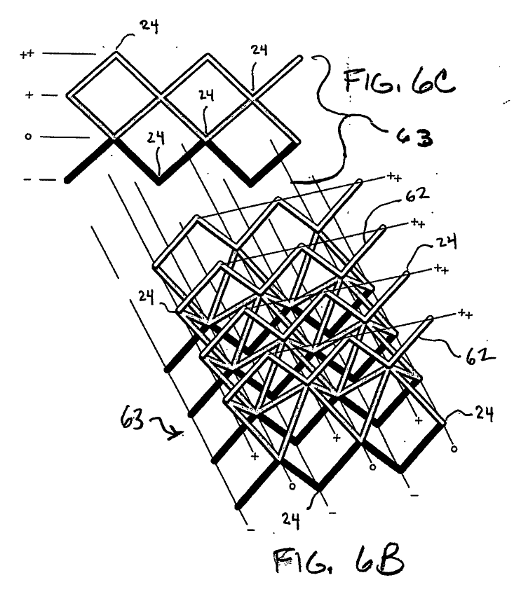

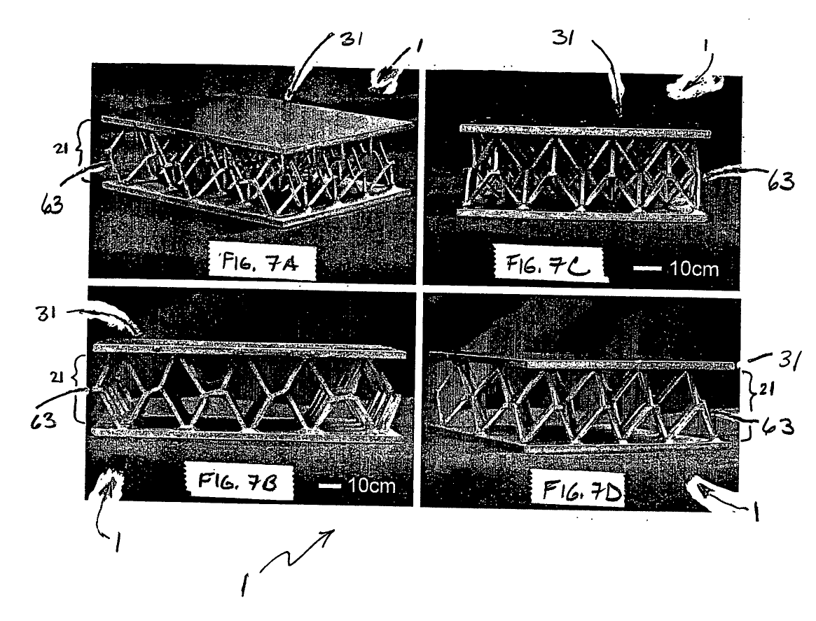

Turning to FIGS. 5 and 6, connecting members 77 and/or 78, such as linear elements, ligaments, etc., pass through or connect between the interior or apertures at the various nodes 24 of a periodic lattice structure of the perform 11. As will be discussed below, the multilayered truss layer 63 is based on diamond lattices with the linear elements or the like passing through appropriate nodes that will create the bilayered and trilayered truss cores as shown in FIGS. 5 and 6, respectively.

For instance, referring to FIG. 5(A), FIG. 5(A) is a schematic plan view of the multilayered tetrahedral truss core preform 11. Above plane, in-plane, and below plane (or approximately thereto) nodes 24 are designated (+), (°), and (−), respectively. FIGS. 5(B)-(C) are an isometric view and a partial elevation view, respectively, of a three dimensional multilayer truss core 63 comprised of a plurality three-dimensional multilayer truss units 62 (here shown as pyramidal) after deformation of the preform 11 of FIG. 5(A). The three dimensional multilayer truss core 63 is a bilayer. As shown in FIG. 5(A), the demonstrated topology of the preform 11 is based on a diamond lattice as designated with backward slashes (\\\\) with connecting members 77 such as linear elements, ligaments, etc., that pass through or connect between the interior or apertures at the various nodes 24 of a periodic lattice structure. It should be appreciated that the topology of the preform 11 is not limited to diamond based lattices.

Referring to FIG. 6(A), FIG. 6(A) is a schematic plan view of the multilayered tetrahedral truss core preform 11. Above plane, in-plane, and below plane (or approximately thereto) nodes 24 are designated (+), (°), and (−), respectively. The nodes of the highest plane (or approximately thereto) will be given a (++) symbol. FIGS. 6(B)-(C) are an isometric view and a partial elevation view, respectively, of a three dimensional multilayer truss core 63 comprised of a plurality three-dimensional multilayer truss units 62 (here shown as pyramidal) after deformation of the preform 11 of FIG. 6(A). The three dimensional multilayer truss core 63 is a trilayer. As shown in FIG. 6(A), the demonstrated topology of the preform 11 is based on a diamond lattice as designated with backward slashes (\\\\) with connecting members 78 such as linear elements, ligaments, etc., that pass through or connect between the interior or apertures at the various nodes of a periodic lattice structure. It should be appreciated that the topology of the preform 11 is not limited to diamond based lattices.

FIGS. 7(A)-(D) provide photographic depictions, at various perspective views, of a completed tetrahedral multilayered truss layer 63 bonded to face members 31 (e.g., facesheets, panels) to form an overall structure 1 of a sandwich panel.

It should be appreciated that the first and/or second face panels 31 (or any provided in addition thereto) as discussed throughout this document can be planar, substantially planar, and/or curved shape, with various contours as desired and required. As such the respective three-dimensional multilayer truss layer(s) 64 (i.e., core 21) may be shaped and bent accordingly. Therefore, the shape or contours of the overall truss layer 63, core 21, and/or face members 31 may be shaped during the punch and die bending process discussed throughout and/or with additional bending as desired or required for required structure or function.

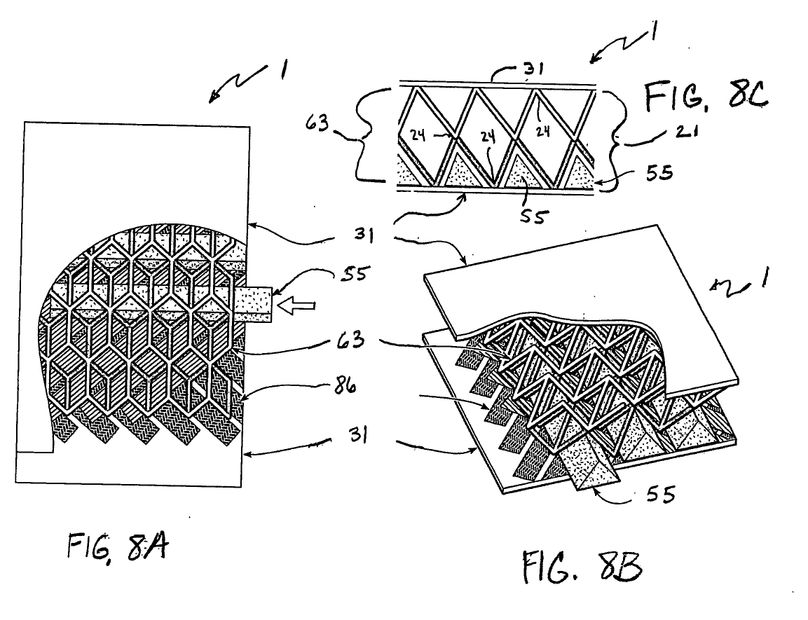

Next, referring to FIG. 8, the multilayered truss cores 21 can be bonded to a face member 31 (such as a facesheet) to create a structure truss core panel 1, such as a sandwich type panel as shown. FIGS. 8(A)-(B) are a schematic plan view and perspective view, respectively, of the multilayered truss core sandwich structure 1 with a partial cut away section exposing an interstitial element 55 that is disposed in or near the interstitial area/space of the core 21 or truss layer 63. FIG. 8(C) is an elevation view of the multilayered truss core sandwich structure shown in FIGS. 8(A)-(B).

It should be appreciated that a plurality of multilayered truss layers 63 can be stacked on top of one another (not shown) and bonded or attached as desired. Further, although not shown, any number of face members (such as a facesheets) 31 may be disposed between a plurality of the multilayered truss layers. Still further, it should be appreciated that the face member 31 (such as a facesheet) need not be a solid sheet. Face panels may be perforated, porous, mesh, or aperture sheet, as well as an array of first intersecting structural elements stacked on a second array of intersecting structural elements, as shown in, for example, PCT International Application No. PCT/US03/16844, entitled “Method for Manufacture of Periodic Cellular Structure and Resulting Periodic Cellular Structure,” filed on May 29, 2003 (of which is hereby incorporated by reference herein in its entirety and is assigned to the present assignee). It should also be appreciated that the panels used between core assemblies may be of any of these structures as well.

Further, although not shown, the face panels may be included on the sides of the core or at various angles. See International Application No. PCT/US03/27606, filed Sep. 3, 2003, entitled “Method for Manufacture of Truss Core Sandwich Structures and Related Method Thereof” (of which is hereby incorporated by reference herein in its entirety and is assigned to the present assignee).

The present invention three dimensional multilayer truss layer 63 or layers can serve as multifunctional structures. The multifunctional features of these sandwich panels 1 or the like may address variety of functions. For example, it may address specific problems in the arenas of ballistic projectile/fragment capture. The truss core panel 1 offers a high stiffness to weight and high energy absorption to weight ratio for civil, aerospace and military structures. The truss core panels can be further augmented, for a minimal weight increase, to contain errant or intended ballistic projectiles (bullets, turbine blade fragments, shrapnel, flying debris, etc.). This may be achieved by the addition of intermediate members 86, such as polymeric fabric strips on the interior faces of the metal facesheets 31. These fabrics act as nets to snare incoming flying objects. Additionally, the interstitial elements 55, such as hard engineered ceramics (i.e., aluminum oxide, silicon carbide, boron carbide, or titanium diboride) can be added to the interior truss core open spaces in the form of prisms or powder infusions. See PCT International Application No. PCT/US03/27605, entitled “Blast and Ballistic Protection Systems and Methods of Making the Same,” filed on Sep. 3, 2003 (of which is hereby incorporated by reference herein in its entirety and is assigned to the present assignee). See PCT/US03/23043, entitled “Method For Manufacture of Cellular Materials and Structures for Blast and Impact Mitigation and Resulting Structure,” filed on Jul. 23, 2003. (of which is hereby incorporated by reference herein in its entirety and is assigned to the present assignee).

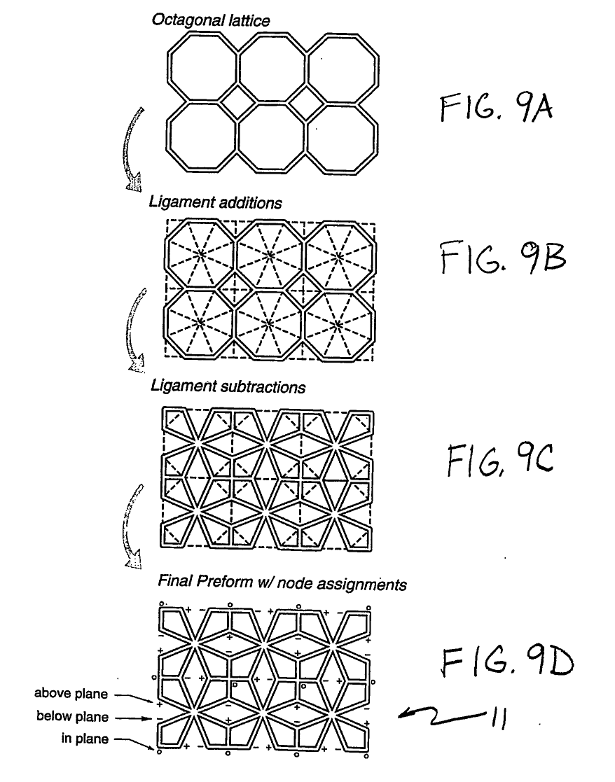

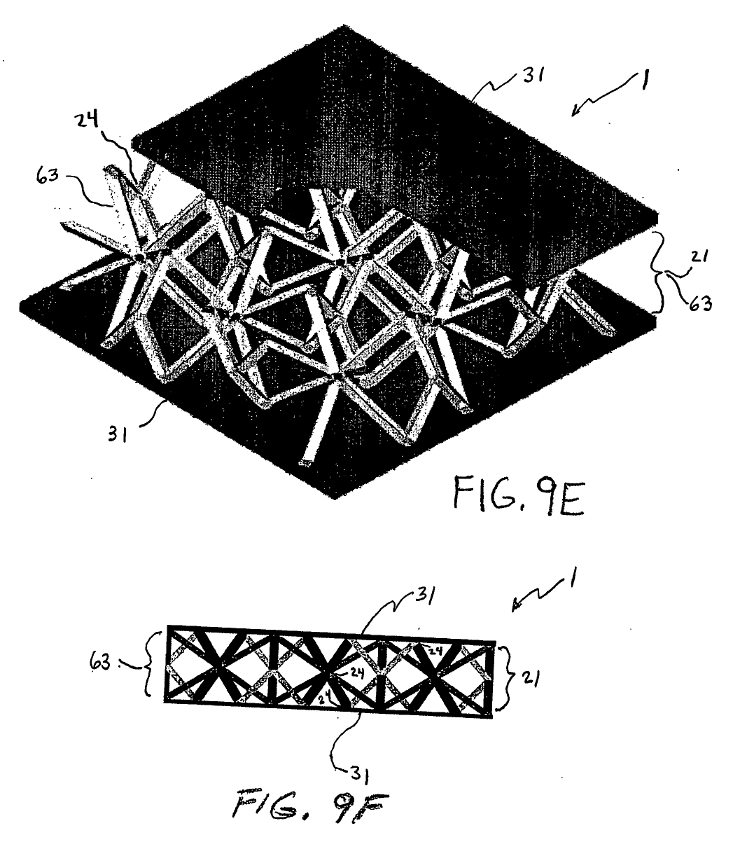

FIG. 9 demonstrates the planar preform buildup of a bilayered core based on an octagonal starting cell to provide a three-dimensional multilayer truss layer based on a septoid lattice. Above plane, in-plane, and below plane nodes (or approximately thereto) are designated (+), (°), and (−) respectively. FIGS. 9(A)-(C) illustrate the various components that may make up the final septoid preform 11 as shown in FIG. 9(D). FIG. 9(A) is a schematic plan view of an octagonal lattice that may become part of a preform 11. Further, as shown in FIG. 9(B), additional ligaments (shown in dotted lines) are added to the octagonal lattice (shown in dual solid lines) from FIG. 9(A). Further yet, referring to FIG. 9(C), select ligament structures are removed from the construction or structure (or alternatively, never added in the first place, although not shown). Alternatively, but not limited thereto, the various components that make up the final septoid preform may be reflected as (but not shown) using four elongated hexagons, wherein one pair of hexagons is rotated ninety degrees and offset with respect to the other pair. As shown in FIG. 9(D), the topology of the preform 11 results in a septoid lattice. The septoid preform 11 is then deformed into the three-dimensional multilayer truss layer 63 as shown in FIGS. 9(E)-(F). FIG. 9(E) provides perspective view of the multilayered truss core sandwich structure 1 with a partial cut away section exposing the three-dimensional multilayer truss layer 63 thereby providing the core 21. FIG. 9(F) is an elevation view of the multilayered truss core sandwich structure shown in FIG. 9(E).

It should also be appreciated that mechanical communication between truss layers or between a truss layer and face member does not necessarily mean direct contact, but may permit, for example, bond-aiding interlayers or other interlayers as desired. Similarly, the attachment of the interstitial elements or intermediate members does not necessarily mean direct contact, but may permit, for example, bond-aiding interlayers or other interlayers as desired.

While the lattice structures as discussed above included various forms of periodic shapes, such as diamonds, hexagons, octagons, and septoids, other periodic shapes or aperture shapes are possible. For example the periodic shapes or apertures may also include, but not limited thereto, circular, square, rectangular, parallelogram hexagonal, triangular, ellipsoidal, pentagonal, octagonal, or combinations thereof or other desired shapes.

The components of the truss layer 63, such as ligaments of the truss units 62 and/or connecting members 77, 78 may be hollow or solid and have variety of shapes such as straight, bent or curved. Further, the ligaments of the truss units 62 and/or connecting members 77, 78 may have a variety of cross-sectional shapes such as square, rectangular, triangular, circular, tubular, or other cross sectional shape, while also having varying widths and thicknesses. The preform 11 may be closed cell analogs (solid or semi solid faces), perforated or combination thereof.

In addition to the high mechanical performance of truss core sandwich structures 1 (in whole or part) and/or the cores 21, lend themselves to multifunctional concepts. Such multifunctional concepts include heat transfer according to the design criteria and function as shown in PCT International Application No. PCT/US01/22266, entitled “Heat Exchange Foam,” filed on Jul. 16, 2001, and corresponding U.S. application Ser. No. 10/333,004, filed Jan. 14, 2003 (of which are hereby incorporated by reference herein in their entirety are assigned to the present assignee).

Another multifunctional concept includes battery or power storage cores, for example, according to the design criteria and concept as shown in PCT International Application No. PCT/US01/25158, entitled “Multifunctional Battery and Method of Making the Same,” filed on Aug. 10, 2001, and corresponding U.S. application Ser. No. 10/110,368, filed Jul. 22, 2002 (of which are hereby incorporated by reference herein in their entirety and are assigned to the present assignee).

There are numerous other functionalities, which can be added into or with these structures 1 (or with the 3D multilayer truss layers 63) making them ideal candidates for “structure plus” multifunctional materials. For example the present invention general structural material may be involved in architecture (for example: pillars, walls, shielding, foundations or floors for tall buildings or pillars, wall shielding floors, for regular buildings and houses), the civil engineering field (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways) and the machine structure field (frame structures for carrying system, carrying pallets, frame structure for robots, etc.), the automobile (the body, frame, doors, chassis, roof and floor, side beams, bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), the space station (the main body, floor, wall, etc.), the submarine, ship, water craft (the body, frame, etc.), and is related to the structural material which requires extreme dynamic strength.

The following patents, applications, and publications are hereby incorporated by reference herein in their entirety:

D. J. Sypeck, H. N. G. Wadley, Cellular Metal Truss Core Sandwich Structures, Advanced Engineering Materials, August 2002.

S. Chiras, et al., The Structural Performance of Near-Optimized Truss Core Panels, Solids & Structures, 39 (2002) pp. 4093-4115.

N. Wickes, J. W. Hutchinson, Optimal Truss Plates, Solids & Structures, 38 (2002) pp. 5165-5183.

International Application No. PCT/US01/17363, filed May 29, 2001, entitled “Multifunctional Periodic Cellular Solids and the Method of Making Thereof” and corresponding U.S. application Ser. No. 10/296,728, filed Nov. 25, 2002 (of which are hereby incorporated by reference herein in their entirety and are assigned to the present assignee).

International Patent Application No. PCT US02/17942, filed Jun. 6, 2002, entitled “Multifunctional Periodic Cellular Solids and the Method of Making Thereof” and corresponding U.S. application Ser. No. 10/479,833 filed Dec. 5, 2003 (of which are hereby incorporated by reference herein in their entirety and are assigned to the present assignee).

### EXAMPLE

Herein provided is an exemplary embodiment to demonstrate a method of manufacturing multilayered truss cores, which and should be considered illustrative only rather than restrictive. The material selected is an aluminum alloy (type 6061). The preform topology is a monolithic tetrahedral bilayer produced by die stamping of an aluminum sheet. The thermal history of the alloy puts it in a fully annealed and recrystallized (i.e., ductile) condition for deformation at room temperature (approximately 25° C.). The deformation method uses an alternating punch and die tool in a comb-like configuration. The preform is aligned to the tool punches, and the top and bottom punch/die assemblies are brought towards each other using a press type operation. The die is then drawn apart and the preform advanced one row and the operation is repeated until the whole preform is converted to a three-dimensional multilayer truss core.

The density of the desired core is controlled by various parameters. A first parameter is the area type density of the preform, determined by the pattern geometry and preform thickness. This is the maximum truss core density. A second parameter is the extent of deformation. This determines the overall truss core height and hence the minimum truss core density, or relative density (if compared to an equivalent solid volume of the same material).

The demonstrated topology may be based on an elongated hexagonal lattice with a second hexagonal lattice overlaid and offset creating an array of three-point and six-point nodes (e.g., as previously provided for FIG. 2). The topology is not limited to hexagonally based lattices. Multilayered trusses based on diamond lattices with linear elements passing through appropriate nodes will create bilayered and trilayered truss core (e.g., as previously shown in FIGS. 5 and 6, respectively).

This demonstrated method utilized a stamped planar preform to achieve the desired topology. It should by noted that this preform can also be created from expanded sheet thereby minimizing the amount of discarded material and hence materials associated costs.

The topological constraints (i.e., the possible number of core layers) imposed by using monolithic preforms can be circumvented by the use of woven textile preforms to achieve a greater number of layers.

As with other network cores, these multilayered truss cores can be bonded (with one of any variety of available bonding techniques or combination thereof or any available fastening means or mechanism) to facesheet material to create structural truss core panels. For example, FIG. 7 shows the bilayered aluminum core brazed to aluminum facesheets.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, section, abstract, drawing figure, etc.) of this application, unless clearly specified to the contrary, there is no requirement for any particular described or illustrated activity or element, any particular sequence of such activities, any particular size, speed, dimension or frequency, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive.

We claim:

1. A method of making a multilayered truss core, said method comprising:
providing a preform member of appropriate topology including a plurality of intersecting members, wherein nodes are formed at said intersections; and
bending said preform member to form a multilayer truss core, wherein:
predetermined selection of said plurality of said nodes remain at least substantially in or are bent at least substantially into a first plane,
predetermined selection of said plurality of said nodes are bent at least substantially into a second plane distal from said first plane, and
predetermined selection of said plurality of said nodes are bent at least substantially into a third plane distal from said first plane and opposite from said second plane, whereby said first plane is between said second plane and said third plane to form said truss core.

2. The method of claim 1, wherein said bending of said preform member results in predetermined selection of said plurality of said nodes are bent at least substantially into a fourth plane that is:
either distal from second plane and opposite direction from said third plane, whereby said second plane is between said first plane and said fourth plane, or
distal from third plane and opposite direction from said second plane, whereby said third plane is between said first plane and said fourth plane.

3. The method of claim 2, further comprising:
bonding a face member in mechanical communication with said truss core.

4. The method of claim 3, further comprising:
bending said truss core and said face member into a desired shape.

5. The method of claim 4, wherein said desired shape comprises a shape that is at least one of curved, planar, substantially planar, or has a plurality of curves.

6. The method of claim 3, further comprising:
bonding a second face member in mechanical communication with said truss core distal from said first face member.

7. The method of claim 6, further comprising:
bending said truss core, said face member, and said second face member into a desired shape.

8. The method of claim 7, wherein said desired shape comprises a shape that is at least one of curved, planar, substantially planar, or has a plurality of curves.

9. The method of claim 2, wherein said truss core comprises a trilayered truss core.

10. The method of claim 2, wherein said truss core comprises a pyramidal truss core.

11. The method of claim 2, wherein shape of said truss core is at least one of curved, planar, substantially planar, or has a plurality of curves.

12. The method of claim 2, further comprising:
bending said truss core into a shape that is at least one of curved, planar, substantially planar, or has a plurality of curves.

13. The method of claim 1, wherein said truss core is curved.

14. The method of claim 1, wherein said truss core is at least substantially planar.

15. The method of claim 1, wherein said truss core is planar.

16. The method of claim 1, wherein said truss core has a plurality of curves.

17. The method of claim 1, wherein said truss core is a bilayered truss.

18. The method of claim 1, wherein said truss core comprises at least one of a pyramidal truss core, septoid truss core or tetrahedral truss core.

19. The method of claim 1, further comprising:
bending said truss core into a shape that is at least one of curved, planar, substantially planar, or has a plurality of curves.

20. The method of claim 1, wherein said preform is comprised of a material of at least one of metals, metal alloys, inorganic polymers, organic polymers, ceramics, glasses, semiconductors, electronic materials and photonic materials, and all composite derivatives.

21. The method of claim 1, wherein said preform is comprised of a composite formed of a material of at least one of metals, metal alloys, inorganic polymers, organic polymers, ceramics, glasses, semiconductors, electronic materials and photonic materials.

22. The method of claim 1, wherein the topology of said preform member includes at least one of stamped sheet goods, woven textiles, expanded sheet goods, expanded metal, laser cut sheets, perforated sheets, and hollow tube arrays or any combination thereof.

23. The method of claim 1, where the bending of the preform is performed at a temperature range to accommodate the bending.

24. The method of claim 23, wherein the temperature range is at a ductile temperature or range of ductile temperatures for said preform.

25. The method of claim 1, wherein the bending process is accomplished by at least one of devices selected from the group consisting of punch die type tool operations, pushing technique tools, nodal tension expansion operations, pulling technique tools, forging, and electric discharge forming.

26. The method of claim 1, further comprising:
bonding a face member in mechanical communication with said truss core.

27. The method of claim 26, wherein said first face member comprise at least one of a panel, perforated structure, porous structure, mesh structure, aperture sheet, or array of intersecting members structure, or any combination thereof.

28. The method of claim 26, further comprising disposing a first intermediate member between said truss and said face member.

29. The method of claim 28, wherein said first intermediate member comprises at least one of strips of fabric, sheets of fabric, imbedded sensor arrays, or heating wires.

30. The method of claim 26, further comprising:
bending said truss core and said face member into a desired shape.

31. The method of claim 30, wherein said desired shape comprises a shape that is at least one of curved, planar, substantially planar, or has a plurality of curves.

32. The method of claim 26, further comprising:
placing an element in the interstitial space of said truss core.

33. The method of claim 32, wherein said interstitial element is at least one of the following prism, rod, block, cylinder, three-dimensional structure, battery, electronic component, or computer component.

34. The method of claim 26, wherein said structure has a shape that is at least one of curved, planar, substantially planar, or has a plurality of curves.

35. The method of claim 26, further comprising:
bonding a second face member in mechanical communication with said truss core distal from said first face member.

36. The method of claim 35, wherein said second face member comprise at least one of a panel, perforated structure, porous structure, mesh structure, aperture sheet, or array of intersecting members structure, or any combination thereof.

37. The method of claim 36, further comprising disposing a second intermediate member between said truss and said second face member.

38. The method of claim 37, wherein said second intermediate member comprises at least one of strips of fabric, sheets of fabric, imbedded sensor arrays, or heating wires.

39. The method of claim 35, further comprising:
bending said truss core, said face member, and said second face member into a desired shape.

40. The method of claim 39, wherein said desired shape comprises a shape that is at least one of curved, planar, substantially planar, or has a plurality of curves.

41. The method of claim 1, further comprising:
placing an element in the interstitial space of said truss core.

42. The method of claim 41, wherein said interstitial element is at least one of the following prism, rod, block, cylinder, three-dimensional structure, battery, electronic component, computer component.

43. The method of claim 1, wherein at least a portion of the topology of said intersecting members are in the form of periodic shapes comprising either:
diamond, hexagonal, septoid or octagonal, and wherein:
said periodic shapes have some of said connecting members in the interior of said periodic shapes.

44. The method of anyone of claims 1, 2, 26, or 35, wherein said truss core comprises at least one of: architecture structure (for example: pillars, walls, shielding, foundations or floors for tall buildings or pillars, wall shielding floors, for regular buildings and houses), civil engineering field structure (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges; girder walls, piers, bridge substructures, towers, dikes and dams, guide ways, railroads, ocean structures such as breakwaters and wharf protection for harbor facilities, floating piers/oil excavation or production platforms, airport structures such as runways) and machine structure field (frame structures for carrying system, carrying pallets, frame structure for robots, etc.), the automobile (the body, frame, doors, chassis, roof and floor, side beams; bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), space station (the main body, floor, wall, etc.), and submarine, ship or water craft (the body, frame, etc.).

45. A multilayered truss core structure comprised of:
at least two integrally formed layers of truss arrays, wherein said layers are free of bonds adapted to otherwise join said first and second layers together.

46. The structure of claim 45, wherein said two layers form a bilayered truss core.

47. The structure of claim 46, wherein said bilayered truss core comprises a pyramidal truss core, septoid truss core or tetrahedral truss core.

48. The structure of claim 45, wherein said truss core has a shape that is at least one of curved, planar, substantially planar, or has a plurality of curves.

49. The structure of claim 45, further comprising an integrally formed third layer immediately adjacent to either said first or second layer.

50. The structure of claim 49, wherein a said third layer are free of bonds between itself and said immediately adjacent said first or second layers.

51. The structure of claim 49, wherein said first, second, and third layers form a trilayered truss core.

52. The structure of claim 49, wherein said trilayered truss core comprises a pyramidal truss core.

53. The structure of claim 45, further comprising:
a face member in mechanical communication with said truss core.

54. The structure of claim 53, wherein said first face member comprise at least one of a panel, perforated structure, porous structure, mesh structure, aperture sheet, or array of intersecting members structure, or any combination thereof.

55. The structure of claim 53, further comprising:
a first intermediate member between said truss and said face member.

56. The structure of claim 55, wherein said first intermediate member comprises at least one of strips of fabric, sheets of fabric, imbedded sensor arrays, or heating wires.

57. The structure of claim 53, further comprising:
an element in the interstitial space of said truss core.

58. The structure of claim 57, wherein said interstitial element is at least one of the following prism, rod, block, cylinder, three-dimensional structure, battery, electronic component, or computer component.

59. The structure of claim 53, wherein said structure is either curved, planar, substantially planar, or has a plurality of curves.

60. The structure of claim 53, further comprising:
a second face member in mechanical communication with said truss core distal from said first face member.

61. The structure of claim 60, wherein said second face member comprise at least one of a panel, perforated structure, porous structure, mesh structure, aperture sheet, or array of intersecting members structure, or any combination thereof.

62. The structure of claim 61, further comprising:
a second intermediate member between said truss and said second face member.

63. The structure of claim 62, wherein said second intermediate member comprises at least one of strips of fabric, sheets of fabric, imbedded sensor arrays, or heating wires.

64. The structure of claim 45, further comprising:
an element in the interstitial space of said truss core.

65. The structure of claim 64, wherein said interstitial element is at least one of the following prism, rod, block, cylinder, three-dimensional structure, battery, electronic component, or computer component.

66. The structure of claim 64, wherein said truss core has a shape that is at least one of curved, planar, substantially planar, or has a plurality of curves.

67. The structure of anyone of claims 45, 53 or 60, wherein said structure comprises at least one of: architecture structure (for example: pillars, walls, shielding, foundations or floors for tall buildings or pillars, wall shielding floors, for regular buildings and houses), civil engineering field structure (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges girder walls, piers, bridge substructures, towers, dikes and dams, guide ways, railroads, ocean structures such as breakwaters and wharf protection for harbor facilities, floating piers/oil excavation or production platforms, airport structures such as runways) and machine structure field (frame structures for carrying system, carrying pallets, frame structure for robots, etc.), the automobile (the body, frame, doors, chassis, roof and floor, side beams, bumpers, etc.), the ship (main frame of the ship, body, deck, partition wall, wall, etc.), freight car (body, frame, floor, wall, etc.), aircraft (wing, main frame, body, floor, etc.), spacecraft (body, frame, floor, wall, etc.), space station (the main body, floor, wall, etc.), and submarine, ship or water craft (the body, frame, etc.).

68. A three dimensional multilayered truss core structure comprised of:
at least two integrally formed layers of truss arrays, wherein said layers are integrally formed with one another without casting.

69. The structure of claim 68, further comprising an integrally formed third layer immediately adjacent to either said first or second layer, wherein said third layer is integrally formed with respective said first or second layer without casting.

70. The structure of claim 68, further comprising an integrally formed third layer immediately adjacent to either said first or second layer.

71. The structure of claim 68, further comprising a third layer in mechanical communication with respective said first or second layer.
